(19) United States
(12) Patent Application Publication
(10) Pub. No.: US 2026/0226262 A1
(43) Pub. Date: Aug. 6, 2026

(54) REINFORCED POLYPROPYLENE RESIN COMPOSITION

(71) Applicant: PRIME POLYMER CO., LTD., Chuo-ku, Tokyo (JP)

(72) Inventor: Yuichi MATSUDA, Sodegaura-shi, Chiba (JP)

(73) Assignee: PRIME POLYMER CO., LTD., Chuo-ku, Tokyo (JP)

(21) Appl. No.: 19/155,545

(22) PCT Filed: Feb. 16, 2024
(86) PCT No.: PCT/JP2024/005634

§ 371 Date: Aug. 11, 2025

(30) Foreign Application Priority Data
Feb. 17, 2023 (JP) 2023-023688

(51) Int. Cl. C08L 23/10; B29C 45/00; B29K 23/00; B29K 307/04; B29K 309/08; C08K 3/04; C08K 3/32; C08K 7/14

(52) U.S. Cl. CPC C08L 23/10; B29C 45/0005; C08K 3/04; C08K 3/32; C08K 7/14; B29K 2023/12; B29K 2307/04; B29K 2309/08; C08K 2003/321; C08L 2205/02

(57) ABSTRACT

An object of the present invention is to provide a molded body that has, while maintaining the levels of flame retardancy and mechanical properties of the molded body composed of a reinforced polypropylene resin composition in which glass fibers, a flame retardant, and an acid modified polypropylene resin have been blended with a polypropylene resin, high commercial value in terms of the appearance of the molded body.

A reinforced polypropylene resin composition including: a polypropylene resin (A); a phosphorus-based flame retardant (B); and glass fibers (C), wherein the polypropylene resin (A) includes an unmodified polypropylene resin (MFR (230° C., load of 2.16 kg) of 100 to 400 g/10 min) (A-1) and an acid modified polypropylene resin (MFR (190° C., load of 2.16 kg) of 100 to 1000 g/10 min, graft amount of acid modification monomers of 0.5 to 3.0% by mass, and graft efficiency of acid modification monomers of more than 60%) (A-2).

### TECHNICAL FIELD

The present invention relates to a reinforced polypropylene resin composition from which a molded body that is excellent in mechanical characteristics and flame retardancy can be obtained.

### BACKGROUND ART

Molded bodies of polypropylene resin reinforced with glass fibers are lightweight and excellent in rigidity and heat resistance, and therefore are utilized in various fields such as electrical equipment, automobiles, housing facilities, and medical appliances.

Also, when glass fibers are blended with polypropylene resin, it is known that an acid modification monomer such as maleic anhydride is grafted onto the polypropylene resin to form acid modified polypropylene, which is used in combination to attempt improvement in the dispersibility of glass fibers in the polypropylene resin and increased adhesion between the polypropylene resin and the glass fibers, thereby improving the mechanical characteristics of the resulting molded body.

Furthermore, molded bodies of polypropylene resin reinforced with glass fibers that contain flame retardants are expected to be utilized in a wide range of applications requiring flame retardancy. Such molded bodies are not always of high commercial value in terms of appearance since contents such as glass fibers and flame retardants may appear on the surface of the molded body, and there is a need for improvement in this regard.

Patent Document 1 discloses a reinforced polypropylene resin composition in which glass fibers, a flame retardant, and an acid modified polypropylene have been blended with a polypropylene resin, and an object thereof is to provide a molded body that satisfies UL94 V-0 and has low warpage while maintaining mechanical properties at high levels.

Also, Patent Document 2 discloses a reinforced polypropylene resin composition in which glass fibers, two flame retardants, and a maleic anhydride-modified polypropylene have been blended with a polypropylene resin, and an object thereof is to provide a resin composition that has excellent flame retardancy and mechanical characteristics and is excellent in flowability.

However, neither Patent Document points out the commercial value in terms of surface and appearance of the molded body.

### CITATION LIST

### Patent Document

[Patent Document 1] WO2022/189647
[Patent Document 2] WO2020/064752

### SUMMARY OF INVENTION

### Technical Problem

An object of the present invention is to provide a molded body that has, while maintaining the levels of flame retardancy and mechanical properties of the molded body composed of a reinforced polypropylene resin composition in which glass fibers, a flame retardant, and an acid modified polypropylene resin have been blended with a polypropylene resin, high commercial value in terms of the appearance of the molded body.

### Solution to Problem

That is, the summary of the present invention is as follows.

### (I)

A reinforced polypropylene resin composition including:
10 to 70% by mass of a polypropylene resin (A);
15 to 40% by mass of a phosphorus-based flame retardant (B);
   and
15 to 60% by mass of glass fibers (C), with respect to 100% by mass of the total of the polypropylene resin (A), the phosphorus-based flame retardant (B), and the glass fibers (C), wherein the polypropylene resin (A) includes
an unmodified polypropylene resin
(MFR (230° C., load of 2.16 kg) of 100 to 400 g/10 min) (A-1)
   and
an acid modified polypropylene resin
(MFR (190° C., load of 2.16 kg) of 100 to 1000 g/10 min,
graft amount of acid modification monomers of 0.5 to 3.0% by mass, and
graft efficiency of acid modification monomers of more than 60%) (A-2).

### (II)

The reinforced polypropylene resin composition according to (I), including:
20 to 60% by mass of the polypropylene resin (A);
20 to 35% by mass of the phosphorus-based flame retardant (B);
   and
20 to 50% by mass of the glass fibers (C), with respect to 100% by mass of the total of the polypropylene resin (A), the phosphorus-based flame retardant (B), and the glass fibers (C).

### (III)

The reinforced polypropylene resin composition according to (I) or (II), wherein the acid modified polypropylene resin (A-2) has a melting point of 150 to 170° C.

### (IV)

The reinforced polypropylene resin composition according to any one of (I) to (III), wherein the polypropylene resin (A) includes the acid modified polypropylene resin (A-2) in a proportion of 0.1 to 3% by mass.

### (V)

The reinforced polypropylene resin composition according to any one of (I) to (IV), wherein the phosphorus-based flame retardant (B) is a phosphate salt compound.

### (VI)

The reinforced polypropylene resin composition according to any of (I) to (V), further including carbon black in a proportion of 0.1 to 2 parts by mass with respect to 100 parts by mass of the total of the polypropylene resin (A), the phosphorus-based flame retardant (B), and the glass fibers (C).

### (VII)

A molded body formed from the reinforced polypropylene resin composition according to any of (I) to (VI).

### Advantageous Effects of Invention

According to the present invention, there can be provided a molded body that has, while maintaining the levels of flame retardancy and mechanical properties of the molded body composed of a reinforced polypropylene resin composition in which glass fibers, a flame retardant, and an acid modified polypropylene resin have been blended with a polypropylene resin, high commercial value in terms of the appearance of the molded body.

### DESCRIPTION OF EMBODIMENTS

The polypropylene resin (A), phosphorus-based flame retardant (B), and glass fibers (C) that constitute the reinforced polypropylene resin composition of the present invention will be described below.

### <Polypropylene Resin (A)>

The polypropylene-based resin (A) is composed of an unmodified polypropylene resin (A-1) and an acid modified polypropylene resin (A-2).

### <Unmodified Polypropylene Resin (A-1)>

The unmodified polypropylene resin (A-1) (sometimes referred to as unmodified PP (A-1)) includes a polypropylene homopolymer and a copolymer of propylene and an α-olefin such as ethylene or butene. Examples of the copolymer include a random copolymer or block copolymer of propylene and at least one α-olefin selected from ethylene and α-olefins having 4 to 20 carbon atoms. The content of the propylene backbone in the random copolymer is normally 90 to 99% by mol, and preferably 92 to 98% by mol. The content of the propylene backbone in the block copolymer is normally 70 to 99% by mol, and preferably 75 to 98% by mol. As the unmodified polypropylene resin (A-1), two or more polypropylene-based resins (for example, a polypropylene homopolymer and a propylene-based copolymer) may be used in combination.

In the case where the unmodified polypropylene resin (A-1) includes a propylene-based copolymer, specific examples of monomers other than propylene to be used in that propylene-based copolymer include ethylene, 1-butene, 2-methyl-1-propene, 2-methyl-1-butene, 3-methyl-1-butene, 1-pentene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methyl ethyl-1-butene, 1-octene, methyl-1-pentene, ethyl-1-hexene, dimethyl-1-hexene, propyl-1-heptene, methyl ethyl-1-heptene, trimethyl-1-pentene, propyl-1-pentene, diethyl-1-butene, 1-nonene, 1-decene, 1-undecene, and 1-dodecene.

Propylene Monomer Derived from Biomass or Chemical Recycling

The unmodified polypropylene resin (A-1) may include biomass-derived propylene as a monomer that constitutes the polymer. The propylene that constitutes the polymer may be only biomass-derived propylene or may include both biomass-derived propylene and fossil fuel-derived propylene. The biomass-derived propylene refers to propylene produced by using, for example, plant-derived or animal-derived every reproducible natural raw material including fungi, yeast, algae, and bacteria, and residues thereof as the raw material, in which the 14C isotope is contained as carbon in a proportion of about 10⁻¹², and the biomass carbon concentration (pMC) measured in accordance with ASTM D 6866 is about 100 (pMC).

Also, the unmodified polypropylene resin (A-1) may include chemical recycling-derived propylene as a monomer that constitutes the polymer. The propylene that constitutes the polymer may be only chemical recycling-derived propylene, or may include chemical recycling-derived propylene and fossil fuel-derived propylene and/or biomass-derived propylene. The chemical recycling-derived propylene is obtained by a conventionally known method.

The unmodified polypropylene resin (A-1) has a melt flow rate (MFR) at 230° C. and a load of 2.16 kg, as measured in accordance with ASTM D1238, of 100 to 400 g/10 min. In addition, among the above, 150 to 350 g/10 min is preferable, and 200 to 300 g/10 min is more preferable.

In the case where the melt flow rate (MFR) is less than 100, there is a tendency that the dispersion of the glass fibers and flame retardant is poor, resulting in reduced strength and deteriorated appearance of the molded body obtained from the reinforced polypropylene resin composition, and it is not possible to obtain a molded body of high commercial value. In the case where the melt flow rate (MFR) is more than 400, the toughness of the reinforced polypropylene resin composition is reduced and it may not be pelletizable at the time of production. In the case where the MFR of the unmodified PP (A-1) is within the range of the present invention, the strength such as impact strength and appearance are excellent as well as flame retardancy. Although the reason for this is not clear, the present inventors speculate that the impregnation to the glass fibers and flame retardant is better, resulting in better dispersibility in the unmodified PP. Note that the present inventors are aware that, in the case where the MFR of the unmodified PP is within the range of the present invention, the Charpy impact tends to be maintained (or is less likely to be reduced) even when the flame retardant (B) is added to the system of unmodified PP (A-1)/modified PP (A-2)/glass fibers (C).

Also, when the MFR of the unmodified polypropylene resin (A-1) is in this range, molding processing can be performed at low temperature, which is advantageous because the flame retardancy is likely to be maintained during recycling or reuse.

The unmodified polypropylene resin (A-1) is preferably an isotactic polypropylene-based resin. The isotactic polypropylene-based resin refers to a polypropylene-based resin in which the isotactic pentad fraction, as determined by the NMR method, is 0.9 or more, and preferably 0.95 or more. Also, the unmodified polypropylene resin (A-1) is generally prepared using a Ziegler-Natta catalyst, metallocene catalyst, or other catalysts.

### <Acid Modified Polypropylene Resin (A-2)>

The acid modified polypropylene resin (A-2) (sometimes referred to as modified PP (A-2)) to be used in the present invention is a resin that is obtained by allowing an acid modification monomer to react with a polypropylene resin and that has a monomer unit derived from the acid modification monomer in the molecule.

The polypropylene resin to be used in acid modification includes, for example, the polymers exemplified as the unmodified polypropylene resin (A-1) described above. The melt flow rate (MFR) of the polypropylene resin to be used can be determined as appropriate, taking into consideration that the acid modification reaction changes (generally decreases) the average molecular weight of the polymer of resin.

Examples of the acid modification monomer to be used in acid modification include, as unsaturated carboxylic acids, maleic acid, fumaric acid, itaconic acid, acrylic acid, methacrylic acid, citraconic acid, crotonic acid, isocrotonic acid, endocis-bicyclo[2.2.1]hept-5-ene-2,3-dicarboxylic acid (nadic acid, TM), and methyl-endocis-bicyclo[2.2.1]hept-5-ene-2,3-dicarboxylic acid (methyl nadic acid, TM).

Examples thereof also include, as unsaturated carboxylic acid derivatives, an acid anhydride, an ester compound, an amide compound, an imide compound, and a metal salt of an unsaturated carboxylic acid. Specific examples of the unsaturated carboxylic acid derivatives include maleic anhydride, itaconic anhydride, methyl acrylate, ethyl acrylate, butyl acrylate, methyl methacrylate, ethyl methacrylate, butyl methacrylate, 2-hydroxyethyl methacrylate, maleic acid monoethyl ester, maleic acid diethyl ester, fumaric acid monomethyl ester, fumaric acid dimethyl ester, acrylamide, methacrylamide, maleic acid monoamide, maleic acid diamide, fumaric acid monoamide, maleimide, N-butylmaleimide, and sodium methacrylate. Among these, it is preferable to use maleic acid or acrylic acid as the unsaturated carboxylic acid, and it is preferable to use maleic anhydride or 2-hydroxyethyl methacrylate as the unsaturated carboxylic acid derivative.

As the method for acid modification, conventionally known methods can be used, and examples thereof include a method in which an acid modification monomer is grafted onto the polypropylene resin. Specifically, an acid modification monomer is grafted onto the polypropylene resin that will serve as the graft main chain in the presence of a radical polymerization initiator.

As the grafting method, conventionally known methods can be used, and examples thereof include the melt kneading method and the solution method.

In the case where the acid modification is performed by the melt kneading method, for example, the polypropylene resin and the acid modification monomer are kneaded together with a radical polymerization initiator in an extruder to perform graft copolymerization with the acid modification monomer for modification.

Examples of the radical polymerization initiator include organic peroxides and azo compounds. Examples of the organic peroxide include benzoyl peroxide, 2,4-dichlorobenzoyl peroxide, m-trioyl peroxide, di-t-butyl peroxide, dicumyl peroxide, 2,5-dimethyl-2,5-bis(t-butylperoxy) hexane, 2,5-dimethyl-2,5-bis(t-butylperoxy) hexyne-3, lauroyl peroxide, t-butyl peroxyacetate, 2,5-dimethyl-2,5-di(benzoylperoxy) hexane, t-butyl peroxybenzoate, t-butyl peroxyisobutyrate, t-butyl peroxyphenylacetate, t-butyl peroxy-s-octate, t-butyl peroxypivalate, cumyl peroxypivalate, and t-butyl peroxyethylacetate.

Examples of the azo compound include azoisobutyronitrile and dimethyl azoisobutyrate. One or two or more radical polymerization initiators can be used.

In the case where the acid modification is performed by the solution method, the polypropylene resin is suspended or dissolved in a solvent, and the acid modification monomer and a radical polymerization initiator are added and mixed for graft polymerization, normally at a temperature of 80 to 200° C.

Examples of the solvent to be used in the solution method include an aromatic hydrocarbon-based solvent such as toluene and xylene, an aliphatic hydrocarbon-based solvent such as hexane, heptane, octane, and decane, an alicyclic hydrocarbon-based solvent such as cyclohexane and methylcyclohexane, a chlorinated hydrocarbon-based solvent such as trichloroethylene, perchloroethylene, dichloroethylene, dichloroethane, and chlorobenzene, an aliphatic alcohol-based solvent such as ethanol and isopropanol, a ketone-based solvent such as acetone, methyl isobutyl ketone, and methyl ethyl ketone, and an ester-based solvent such as methyl acetate, ethyl acetate, and butyl acetate. One or two or more solvents can be used.

As specific examples of the radical polymerization initiator, for example, the same peroxides as described above can be used.

The acid modified polypropylene resin (A-2) has a melt flow rate (MFR) (190° C., load of 2.16 kg) of 100 to 1000 g/10 min. Among the above, 100 to 750 g/10 min is preferable, and furthermore, 100 to 500 g/10 min is particularly preferable.

In the case where the melt flow rate (MFR) of the acid modified polypropylene resin (A-2) is less than 100, there is a tendency that the appearance of the molded body obtained from the reinforced polypropylene resin composition cannot be said to be sufficient, and that it is not possible to obtain a molded body of high commercial value.

Also, the graft amount of acid modification monomers in the acid modified polypropylene resin (A-2) is 0.5 to 3.0% by mass. Among the above, 0.3 to 2.0% by mass is preferable, and furthermore, 0.5 to 1.5% by mass is particularly preferable.

The graft amount of acid modification monomers (% by mass) is the proportion of monomers derived from the acid modification monomer in the acid modified polypropylene resin (A-2), that is, the value of the proportion of monomers that are not removed by the solvent (reflecting the monomers that are chemically bonded to the main chain of the polypropylene resin) as the proportion (% by mass) in the acid modified polypropylene resin (A-2).

For example, the acid modified polypropylene resin (A-2) is completely dissolved by heating in boiling p-xylene, and after allowing the p-xylene solution in which the acid modified polypropylene resin (A-2) has been dissolved to be cooled, acetone is added so that the polymer is precipitated while stirring. The precipitated polymer is filtered and dried to obtain a polymer purified product. The proportion of monomers derived from the acid modification monomer included in this polymer purified product (% by mass) is used as the graft amount of acid modification monomers (% by mass).

This graft amount (% by mass) can be measured and calculated utilizing, for example, the infrared absorption spectrum or NMR spectrum.

The graft efficiency (%) of acid modification monomers in the acid modified polypropylene resin (A-2) when used in the reinforced polypropylene resin composition is more than 60%.

That is, the graft efficiency (%) in the acid modified polypropylene resin (A-2) is measured when it is used to prepare the reinforced polypropylene resin composition, or when it is used as a component when molding a molded body made of the reinforced polypropylene resin composition.

This graft efficiency (%) is preferably more than 60%, and furthermore, it is particularly preferably more than 65%.

In the case where the graft efficiency (%) of acid modification monomers in the acid modified polypropylene resin (A-2) is less than 60%, there is a tendency that the strength of the molded body obtained from the reinforced polypropylene resin composition is reduced and the appearance cannot be said to be sufficient, and it is not possible to obtain a molded body of high commercial value.

The graft efficiency (%) of acid modification monomers can be determined as follows.

That is, the mass X (g/100 g of sample polymer) of monomers derived from the acid modification monomer (including the monomers that are chemically bonded to the polymer main chain of the polypropylene resin, as well as monomers remaining in the resin that are not chemically bonded to the polymer main chain in the grafting reaction and are to be eluted by the solvent) in the sample of the acid modified polypropylene resin (A-2) is determined.

Furthermore, the mass Y (g/100 g of sample polymer) of monomers derived from the acid modification monomer in the sample polymer after the operation of removing the acid modification monomer from the acid modified polypropylene resin (A-2) by the solvent, that is, the mass of monomers derived from the acid modification monomer that is not removed by the solvent (reflecting the monomers that are chemically bonded to the polymer main chain) is determined.

The graft efficiency (%) is the value obtained from these according to the expression below:

$$[ Y / X ] \times 100 = graft efficiency ( \% ) .$$

For example, in the case where the acid modification monomer is maleic anhydride, the mass X (g) of the acid modification monomer included in the acid modified polypropylene resin (A-2) (including the monomers derived from the acid modification monomer that are chemically bonded to the polymer main chain, as well as monomers remaining in the resin that are not chemically bonded to the polymer main chain in the grafting reaction and are to be eluted by the solvent) can be obtained by making a film from the acid modified polypropylene resin (A-2) by pressing, and determining it from the intensity ratio of infrared absorption peaks at 1780 cm⁻¹ and 974 cm⁻¹ by Fourier transform infrared spectroscopy (FT-IR) for the film.

Also, the mass Y (g) of the acid modification monomer after the operation of removing the acid modification monomer from the acid modified polypropylene resin (A-2) by the solvent, that is, the mass of the acid modification monomer that is not removed by the solvent (reflecting the monomers derived from the acid modification monomer that are chemically bonded to the polymer main chain) can be obtained as follows. About 2 g of the acid modified polypropylene resin is collected, completely dissolved by heating in 500 ml of boiling p-xylene, cooled, and then placed in 1200 ml of acetone. The precipitate is filtered to remove maleic anhydride in the resin that has not contributed to the grafting reaction. From that polymer precipitate, a film is made by pressing, and the mass can be determined from the intensity ratio of infrared absorption peaks at 1780 cm⁻¹ and 974 cm⁻¹ by Fourier transform infrared spectroscopy (FT-IR) in the same manner.

The graft efficiency (%) is the value obtained from these according to the following expression:

$$[ Y / X ] \times 100 = graft efficiency ( \% ) .$$

Also, the acid modified polypropylene resin (A-2) desirably has a melting point of 150 to 170° C.

### <Phosphorus-Based Flame Retardant (B)>

The phosphorus-based flame retardant (B) includes, for example, a red phosphorus-based compound, a phosphate salt compound, a phosphate ester, a phosphinate salt, and a phosphazene compound, among which a phosphate salt compound is suitable.

### <Phosphate Salt Compound>

The phosphate salt compound includes not only phosphate salts, but also salts of polyphosphoric acids such as diphosphoric acid (pyrophosphoric acid) and triphosphoric acid, as well as phosphorous acid, and hypophosphorous acid (phosphinic acid).

Examples of the phosphate salt may include, as salts with the various phosphoric acids described above, salts with ammonium and nitrogen compounds such as piperazine and melamine.

As specific examples thereof, ammonium salts include, for example, ammonium phosphate, ammonium dihydrogen phosphate, and diammonium hydrogen phosphate.

Polyphosphate salts include, for example, ammonium polyphosphate and ammonium polyphosphate amide.

In the present invention, among phosphate salts, salts of, for example, phosphoric acid, diphosphoric acid (pyrophosphoric acid), and triphosphoric acid with nitrogen compounds such as piperazine and melamine are suitable, and for such nitrogen compounds, the following can be exemplified.

Aliphatic diamines include, for example, N, N,N′, N′-tetramethyldiaminomethane, ethylenediamine, N,N′-dimethylethylenediamine, N,N′-diethylethylenediamine, N, N,N′, N′-tetramethylethylenediamine, N, N,N′, N′-tetraethylethylenediamine, 1,2-propanediamine, 1,3-propanediamine, tetramethylenediamine, and pentamethylenediamine.

Amine compounds that include a piperazine ring include, for example, piperazine, trans-2,5-dimethylpiperazine, and 4-bis(2-aminoethyl) piperazine.

Amine compounds that include a triazine ring include, for example, melamine, acetoguanamine, benzoguanamine, acrylguanamine, 2,4-diamino-6-nonyl-1,3,5-triazine, and 2,4-diamino-6-hydroxy-1,3,5-triazine.

Among these, salts of nitrogen compounds such as piperazine and melamine are suitable, among which at least one compound selected from the group consisting of piperazine phosphate, piperazine pyrophosphate, and piperazine polyphosphate is preferable.

### <Phosphazene Compound>

The phosphazene compound includes, for example, phenoxyphosphazene, (poly)tolyloxyphosphazene (for example, o-tolyloxyphosphazene, o, p-tolyloxyphosphazene), (poly)xylyloxyphosphazene, (poly)phenoxytolyloxyphosphazene (for example, phenoxy o-tolyloxyphosphazene, phenoxy m-tolyloxyphosphazene), (poly)phenoxyxylyloxyphosphazene, and (poly)phenoxytolyloxyxylyloxyphosphazene.

The content of the phosphorus-based flame retardant (B) in the reinforced polypropylene resin composition is 15 to 40% by mass.

(However, the total of the polypropylene resin (A), the phosphorus-based flame retardant (B), and the glass fibers (C) is 100% by mass.)

The content of the phosphorus-based flame retardant (B) is preferably in the range of 20 to 35% by mass.

When the amount of the phosphorus-based flame retardant (B) is small, the molded body of the reinforced polypropylene resin cannot obtain proper flame retardancy, and when the amount of the phosphorus-based flame retardant (B) is too large, there is a tendency that the molded body cannot obtain sufficient commercial value in terms of its appearance.

Note that the phosphorus-based flame retardant is excellent in environmental compatibility as well, since it is a non-halogen-based flame retardant.

### <Glass Fibers (C)>

The type of the glass fibers (C) is not particularly limited, and it may be any of E-glass, S-glass, C-glass, and A-glass. The fiber diameter is not particularly limited either, but it is normally 5 to 25 μm, and preferably 6 to 20 μm.

The form of the glass fibers (C) is preferably chopped strands. The chopped strands are normally 1.5 to 10 mm in length and 5 to 25 μm in fiber diameter, and preferably 3 to 6 mm in length and 6 to 17 μm in fiber diameter. As another form, continuous fiber bundles can also be used. The continuous fiber bundles are commercially available, for example, as rovings. The fiber diameter is normally 5 to 25 μm, and preferably 10 to 20 μm.

Although the glass fibers (C) can be used as they are, those that have been subjected to a surface treatment with a treatment agent such as an organic titanate-based coupling agent, an organic silane coupling agent, a modified polyolefin grafted with an unsaturated carboxylic acid or its anhydride, a fatty acid, a fatty acid metal salt, or a fatty acid ester are preferable. Those in which the compound used as the surface treatment agent contains an amino group are still more preferable. Also, the surface may be treated with a thermosetting or thermoplastic resin component.

In the reinforced polypropylene-based resin composition of the present invention, as necessary, additives such as other resin, a heat-resistant stabilizer, an antistatic agent, a weathering stabilizer, a light-resistant stabilizer, an anti-aging agent, an antioxidant, a copper inhibitor, a fatty acid metal salt, a softener, a dispersant, a filler, a colorant, a pigment, and a foaming agent can be blended as long as the object of the present invention is not impaired. The order of mixing the additives is arbitrary, and they may be mixed at the same time, or a multi-stage mixing method in which some components are mixed and then the other components are mixed can be used. In particular, it is preferable to blend carbon black, or a phenol-based antioxidant and/or a sulfur-based antioxidant.

Among the above, it is suitable for carbon black to be included in the reinforced polypropylene-based resin composition of the present invention in a proportion of 0.1 to 2 parts by mass with respect to 100 parts by mass of the total of the polypropylene resin (A), the phosphorus-based flame retardant (B), and the glass fibers (C) in the composition.

### <Reinforced Polypropylene Resin Composition>

The reinforced polypropylene resin composition of the present invention includes:
10 to 70% by mass of the polypropylene resin (A);
15 to 40% by mass of the phosphorus-based flame retardant (B);
and
15 to 60% by mass of the glass fibers (C), in the above compositional features. In particular, the compositional features are suitably as follows:
20 to 60% by mass of the polypropylene resin (A);
20 to 35% by mass of the phosphorus-based flame retardant (B);
and
20 to 50% by mass of the glass fibers (C). More preferably, the compositional features are as follows:
23 to 49% by mass of the polypropylene resin (A);
20 to 32% by mass of the phosphorus-based flame retardant (B); and
25 to 45% by mass of the glass fibers (C).

In this range, the effect of adding the polypropylene resin (A) component is particularly significant. (However, the total of the polypropylene resin (A), the phosphorus-based flame retardant (B), and the glass fibers (C) is 100% by mass.)

Also, the reinforced polypropylene resin composition suitably includes the acid modified polypropylene resin (A-2) in a proportion of 0.1 to 3% by mass, of which inclusion in a proportion of 0.5 to 2% by mass is still more suitable. (However, the total of the unmodified polypropylene resin (A-1), the acid modified polypropylene resin (A-2), the phosphorus-based flame retardant (B), and the glass fibers (C) is 100% by mass.)

### <Preparation of Reinforced Polypropylene Resin Composition>

The reinforced polypropylene resin composition of the present invention has high impact resistance. This composition can be made into pellets, which may be glass short fiber pellets containing short fibers as the glass fibers (C) or may be glass long fiber pellets containing long fibers as the glass fibers (C).

The reinforced polypropylene resin composition of the present invention can be produced by melt kneading the polypropylene resin (A), the phosphorus-based flame retardant (B), the glass fibers (C), and other components as necessary. The melt kneading temperature is, for example, a temperature 5 to 100° C. higher than the temperature at which the contained component polymers are melted, and is preferably a temperature 10 to 60° C. higher than the melting point of the polymer having the highest melting point among the contained component polymers. Also, the melt kneading treatment time is, for example, 30 seconds or longer and 15 minutes or shorter, and preferably 1 to 10 minutes.

In the case where the glass fibers (C) in the reinforced polypropylene resin composition of the present invention are short fibers, the composition can be produced by melt kneading and dispersing each component well with, for example, a roll mill, a Banbury mixer, or a kneader in an extruder, for example. The components may be dry blended with, for example, a tumbler type blender, a Henschel mixer, or a ribbon mixer, and then melt kneaded with, for example, a single screw extruder or twin screw extruder, to form a molding material in the form of pellets. In this method, the glass fibers (C) may be fed from either the top or side of the extruder. Also, in this method, all or part of each component other than the glass fibers (C) may be separately melt kneaded and then melt kneaded with the glass fibers (C).

The reinforced polypropylene resin composition of the present invention can be processed into a molded body by an ordinary molding method such as injection molding, extrusion molding, or press molding. In the case of injection molding, for example, injection molding can be carried out using the glass short fiber pellets or glass long fiber pellets described above. In that case, other resin can be further added when the glass short fiber pellets or glass long fiber pellets are fed from the hopper of the injection molding machine. Alternatively, the glass short fiber pellets or glass long fiber pellets can be side-fed from, for example, the vent port of the injection molding machine while feeding other resin from the hopper to mix them in the injection molding machine and then mold them.

Also, molding can be carried out by melt kneading the polypropylene resin (A) in an injection molding machine without going through glass short fiber pellets or glass long fiber pellets. In that case, the glass fibers (C) may be fed from the hopper of the injection molding machine or side-fed from, for example, a vent port.

The molded body may be formed from the reinforced polypropylene resin composition of the present invention in its entirety, or the molded body may include a portion formed from the reinforced polypropylene resin composition of the present invention as a part of it. The molded body is used in a wide range of applications, from household commodities, such as daily commodities and recreational applications, to general industrial applications and industrial products. Examples of applications include home appliance material components, communication equipment components, electrical components, electronic components, automobile components, components for vehicles other than automobiles, ships, aircraft materials, machine mechanism components, construction material-related members, civil engineering members, agricultural materials, power tool components, food containers, films, sheets, and fibers.

Examples of home appliance material components, communication equipment components, electrical components, and electronic components include office and OA equipment such as battery pack components (covers, trays, module cases), printers, PCs, word processors, keyboards, personal digital assistants (PDAs), headphone stereos, cellular phones, telephones, facsimiles, copying machines, cards, holders, and stationery; and home appliance equipment such as washing machines, refrigerators, vacuum cleaners, microwave ovens, lighting fixtures, and game consoles.

### EXAMPLES

Hereinafter, the present invention will be described further specifically based on Examples and Comparative Examples.

However, the present invention is not limited to these Examples.

The measurement methods and evaluation methods for the compositions used in Examples and Comparative Examples are as follows.

(1) Melt Flow Rate (MFR) (g/10 Min)

The melt flow rate (MFR) of the unmodified polypropylene resin (A-1) was measured under conditions at 230° C. and a load of 2.16 kg in accordance with ISO 1133.

The melt flow rate (MFR) of the acid modified polypropylene resin (A-2) was measured under conditions at 190° C. and a load of 2.16 kg in accordance with ISO 1133.

### (2a) Graft Amount of Maleic Anhydride (% by Mass)

About 2 g of the acid modified polypropylene resin that had been modified with maleic anhydride was collected, and completely dissolved by heating in 500 ml of boiling p-xylene.

After cooling, the solution was placed in 1200 ml of acetone, and the polymer precipitate was filtered and dried to obtain a polymer purified product. From this, a film with a thickness of 20 μm was fabricated by heat pressing.

The infrared absorption spectrum of this fabricated film was measured, and the graft amount of maleic anhydride was quantified by absorption near 1780 cm⁻¹.

### (2b) Graft Efficiency of Maleic Anhydride (%)

The mass X (g/100 g of sample polymer) of the acid modification monomer included in the acid modified polypropylene resin (A-2) is obtained by making a film by pressing from the sample polymer of the acid modified polypropylene resin (A-2) when used in the reinforced polypropylene resin of the present invention, and determining it from the intensity ratio of infrared absorption peaks at 1780 cm⁻¹ and 974 cm⁻¹ by Fourier transform infrared spectroscopy (FT-IR) for the film.

Also, the mass Y (g/100 g of sample polymer) of the acid modification monomer in the sample polymer after the operation of removing the acid modification monomer by the solvent from the acid modified polypropylene resin (A-2) when used in the reinforced polypropylene resin of the present invention is obtained as follows. About 2 g of the acid modified polypropylene resin is collected, completely dissolved by heating in 500 ml of boiling p-xylene, cooled, and then placed in 1200 m of acetone. The precipitate is filtered to remove maleic anhydride in the resin that has not contributed to the grafting reaction. From that polymer precipitate, a film is made by pressing, and the mass is determined from the intensity ratio of infrared absorption peaks at 1780 cm⁻¹ and 974 cm⁻¹ by Fourier transform infrared spectroscopy (FT-IR) in the same manner.

The graft efficiency (%) is determined from these according to the expression below:

$$[ Y / X ] \times 100 = graft efficiency ( \% ) .$$

### (3) Tensile Breaking Stress (MPa)

An ISO 1A dumbbell was molded using an injection molding machine FANUCα-100iA at a cylinder temperature of 220° C. and a die temperature of 40° C., and the tensile breaking stress was measured under conditions with a tensile speed of 5 mm/min in accordance with ISO 527.

(4) Charpy Impact Strength (kJ/m²)

An ISO 1A dumbbell was molded using an injection molding machine FANUCα-100iA at a cylinder temperature of 220° C. and a die temperature of 40° C., and the Charpy impact strength was measured in accordance with ISO 179.

### (5) Flame Retardancy UL94-V

A test piece with a thickness of 1.6 mm was molded using an injection molding machine FANUCα-100iA at a cylinder temperature of 220° C. and a die temperature of 40° C., and the flame retardancy was evaluated in accordance with the UL94-V standard. Note that, in the case where the judgment does not satisfy UL94-V, it is indicated as non-conformity. Also, the total time for which the test specimen burned was measured as the total burning time (sec).

### (6) Appearance of Test Piece

An ISO 1A dumbbell was molded using an injection molding machine FANUCα-100iA at a cylinder temperature of 220° C. and a die temperature of 40° C., and the appearance of the dumbbell surface was visually evaluated.

One with uniformly dispersed flame retardant and/or glass fibers and good appearance is indicated as 0.
One with non-uniformly dispersed flame retardant and/or glass fibers and speckled appearance is indicated as X.

Each component used in Examples and Comparative Examples are as follows.

### <Polypropylene Resin (A)>

### <Unmodified Polypropylene Resin (A-1)>

(A-1-1) Polypropylene homopolymer manufactured by Prime Polymer Co., Ltd.,
with a MFR of 200 g/10 min, as measured at 230° C. and a load of 2.16 kg
(A-1-2) Polypropylene homopolymer manufactured by Prime Polymer Co., Ltd,
with a MFR of 30 g/10 min, as measured at 230° C. and a load of 2.16 kg
(A-1-3) Polypropylene homopolymer manufactured by Prime Polymer Co., Ltd,
with a MFR of 500 g/10 min, as measured at 230° C. and a load of 2.16 kg
(A-1-4) Polypropylene homopolymer manufactured by Prime Polymer Co., Ltd,
with a MFR of 60 g/10 min, as measured at 230° C. and a load of 2.16 kg
(A-1-5) Propylene ethylene block copolymer manufactured by Prime Polymer Co., Ltd,
with a MFR of 90 g/10 min, as measured at 230° C. and a load of 2.16 kg

### <Acid Modified Polypropylene Resin (A-2)>

(A-2-1) Maleic anhydride-modified polypropylene manufactured by Polymer Asia,
with a MFR of 180 g/10 min, as measured at 190° C. and a load of 2.16 kg,
with a melting point of 158° C., as detected using a differential scanning calorimeter, and
with a graft amount of maleic anhydride of 0.7% by mass (trade name: PA-Bond 700ZV)
(A-2-2) Maleic anhydride-modified polypropylene manufactured by SI Group, Inc.,
with a MFR of 110 g/10 min, as measured at 190° C. and a load of 2.16 kg,
with a melting point of 158° C., as detected using a differential scanning calorimeter, and
with a graft amount of maleic anhydride of 0.5% by mass (trade name: Polybond 3200)
(A-2-3) Maleic anhydride-modified polypropylene manufactured by Prime Polymer Co., Ltd.,
with a MFR of 30 g/10 min, as measured at 190° C. and a load of 2.16 kg,
with a melting point of 156° C., as detected using a differential scanning calorimeter, and
with a graft amount of maleic anhydride of 0.3% by mass (trade name: ZP648)
(A-2-4) Maleic anhydride-modified polypropylene manufactured by Dow Chemical Company,
with a MFR of 400 g/10 min, as measured at 190° C. and a load of 2.16 kg,
with a melting point of 134° C., as detected using a differential scanning calorimeter, and
with a graft amount of maleic anhydride of 0.9% by mass (trade name: Fusabond P353)

### <Phosphorus-Based Flame Retardant (B)>

“FP-2300S”: Phosphate salt-based flame retardant with piperazine phosphate as the main component (manufactured by ADEKA Corporation, trade name: FP-2300S)

### <Glass Fibers (C)>

“T-480”: Glass fibers (manufactured by Nippon Electric Glass Co., Ltd., trade name: T-480)

### <Carbon Black Masterbatch>

“PPM01143”: with polypropylene as the carrier resin containing 30% by mass of carbon black (manufactured by Toyochem Co., Ltd., trade name: PPM01143)
“PPM0127A”: with polypropylene as the carrier resin containing 40% by mass of carbon black (manufactured by Toyochem Co., Ltd., trade name: PPM0127A)

### <Antioxidant>

“Irg 1010”: Phenol-based antioxidant
   (manufactured by BASF SE, trade name: Irganox (R) 1010)
“DMTP”: Sulfur-based antioxidant
   (manufactured by Mitsubishi Chemical Corporation, trade name: DMTP)

### Examples 1 to 8 and Comparative Examples 1 to 5

The unmodified polypropylene resin (A-1), the acid modified polypropylene resin (A-2), the phosphorus-based flame retardant (B), the carbon black masterbatch, and other components shown in Table 1 were uniformly mixed using a tumbler mixer, and the mixture was fed into a co-rotating twin screw kneader (manufactured by The Japan Steel Works, Ltd., TEX (R) 30α). Next, the glass fibers (C) were side-fed from the middle of the twin screw kneader, and heating and kneading at 210° C. were performed to obtain pellets of the fiber-reinforced, reinforced polypropylene resin composition.

Each pellet was used to mold an ISO No. 1 dumbbell test piece using an injection molding machine (FANUC) at a molding temperature of 220° C. and a die temperature of 40° C., and using this, the tensile breaking stress and the Charpy impact strength were measured. The results are shown in Table 1.

Note that the proportion of the carbon black masterbatch and the antioxidant blended is expressed as a proportion blended (phr) with respect to 100 parts by mass of the total of the unmodified polypropylene resin (A-1), the acid modified polypropylene resin (A-2), the phosphorus-based flame retardant (B), and the glass fibers (C).

Also, the amount of the carbon black is expressed as a proportion blended (phr) with respect to 100 parts by mass of the total of the polypropylene resin (A), the phosphorus-based flame retardant (B), and the glass fibers (C).

TABLE 1

| Configuration | | | | | | | | | | | | | | | | | | |
|---|---|---|---|---|---|---|---|---|---|---|---|---|---|---|---|---|---|---|
| of | | | | | Example | | | | | | | | Comparative Example | | | | | |
| composition | | | | Unit | 1 | 2 | 3 | 4 | 5 | 6 | 7 | 8 | 1 | 2 | 3 | 4 | 5 | 6 |
| Unmodified | (A-1-1) MFR = 200 | | | % by | 44 | 39 | 43 | 44 | 34 | 34 | 30 | 19 | | 43 | | | | |
| polypropylene | | | | mass | | | | | | | | | | | | | | |
| resin (A-1) | (A-1-2) MFR = 30 | | | % by | | | | | | | 4 | | | | | | | |
| | | | | mass | | | | | | | | | | | | | | |
| | (A-1-3) MFR = 500 | | | % by | | | | | | | | 15 | | | | 34 | | |
| | | | | mass | | | | | | | | | | | | | | |
| | (A-1-4) MFR = 60 | | | % by | | | | | | | | | 49 | | 44 | | 34 | |
| | | | | mass | | | | | | | | | | | | | | |
| | (A-1-5) MFR = 90 | | | % by | | | | | | | | | | | | | | 34 |
| | | | | mass | | | | | | | | | | | | | | |
| Acid modified | (A-2-1) MFR = 180 | | | % by | 1 | 1 | 2 | | 1 | 1 | 1 | 1 | 1 | | | 1 | 1 | 1 |
| polypropylene | | | | mass | | | | | | | | | | | | | | |
| resin (A-2) | (A-2-2) MFR = 110 | | | % by | | | | 1 | | | | | | | | | | |
| | | | | mass | | | | | | | | | | | | | | |
| | (A-2-3) MFR = 30 | | | % by | | | | | | | | | | 2 | | | | |
| | | | | mass | | | | | | | | | | | | | | |
| | (A-2-4) MFR = 400 | | | % by | | | | | | | | | | | 1 | | | |
| | | | | mass | | | | | | | | | | | | | | |
| Phosphorus- | FP-2300 flame retardant | | | % by | 25 | 20 | 25 | 25 | 25 | 25 | 25 | 25 | 20 | 25 | 25 | 25 | 25 | 25 |
| based flame | | | | mass | | | | | | | | | | | | | | |
| retardant (B) | | | | | | | | | | | | | | | | | | |
| Glass fibers | T-480 GF | | | % by | 30 | 40 | 30 | 30 | 40 | 40 | 40 | 40 | 30 | 30 | 30 | 40 | 40 | 40 |
| (C) | | | | mass | | | | | | | | | | | | | | |
| Carbon black | PPM01143 MB 30% | | | phr | | | 1 | 1 | 1 | | 1 | 1 | | 1 | 1 | 1 | 1 | 1 |
| masterbatch | by mass of CB | | | | | | | | | | | | | | | | | |
| (carrier resin | PPM0127A MB 40% | | | phr | | | | | | 3 | | | | | | | | |
| PP) | by mass of CB | | | | | | | | | | | | | | | | | |
| Antioxidant | Irg1010 | | | phr | 0.1 | 0.1 | 0.1 | 0.1 | 0.1 | 0.1 | 0.1 | 0.1 | 0.1 | 0.1 | 0.1 | 0.1 | 0.1 | 0.1 |
| | DMTP | | | phr | 0.1 | 0.1 | 0.1 | 0.1 | 0.1 | 0.1 | 0.1 | 0.1 | 0.1 | 0.1 | 0.1 | 0.1 | 0.1 | 0.1 |
| MFR of unmodified polypropylene resin | | | | g/10 | 200 | 200 | 200 | 200 | 200 | 200 | 150 | 300 | 60 | 200 | 60 | 500 | 60 | 90 |
| (A-1) | | | | min | | | | | | | | | | | | | | |
| MFR of acid modified polypropylene resin | | | | g/10 | 180 | 180 | 180 | 115 | 180 | 180 | 180 | 180 | 180 | 30 | 400 | 180 | 180 | 180 |
| (A-2) | | | | min | | | | | | | | | | | | | | |
| Acid modified polypropylene resin | | | Graft | % by | 0.7 | 0.7 | 0.7 | 0.5 | 0.7 | 0.7 | 0.7 | 0.7 | 0.7 | 0.3 | 0.9 | 0.7 | 0.7 | 0.7 |
| (A-2) | | | amount | mass | | | | | | | | | | | | | | |
| | | | Graft | % | 97 | 97 | 97 | 70 | 97 | 97 | 97 | 97 | 97 | 60 | 60 | 97 | 97 | 97 |
| | | | efficiency | | | | | | | | | | | | | | | |
| Melting point of acid modified polypropylene | | | | ° C. | 158 | 158 | 158 | 154 | 158 | 158 | 158 | 158 | 158 | 156 | 134 | 158 | 158 | 158 |
| resin (A-2) | | | | | | | | | | | | | | | | | | |
| Amount of carbon black in reinforced | | | | phr | 0 | 0 | 0.30 | 0.30 | 0.30 | 1.16 | 0.30 | 0.30 | 0 | 0.30 | 0.30 | 0.30 | 0.30 | 0.30 |
| polypropylene resin composition | | | | | | | | | | | | | | | | | | |
| Evaluation | Tensile breaking stress | | | MPa | 109 | 122 | 106 | 105 | 120 | 115 | 118 | 120 | 98 | 103 | 96 | Strands | 102 | 104 |
| results | Charpy impact strength | | | kJ/m2 | 13 | 15 | 13 | 13 | 16 | 14 | 15 | 17 | 12 | 12 | 11 | not drawn | 13 | 11 |
| | Flame | UL94-V | Rank | 1/16 | V-0 | V-0 | V-0 | V-0 | V-0 | V-0 | V-0 | V-0 | Non- | V-0 | V-0 | and | V-0 | V-0 |
| | retardancy | | | inches | | | | | | | | | conformity | | | sampling | | |
| | | | Total | sec | 0 | 0 | 0 | 0 | 0 | 0 | 0 | 0 | — | 0 | 5 | not | 7 | 1 |
| | | | burning | | | | | | | | | | | | | possible | | |
| | | | time | | | | | | | | | | | | | | | |

| | | | | | | | | | | | | | | |
|---|---|---|---|---|---|---|---|---|---|---|---|---|---|---|
| Appearance of test piece | — | ◯ | ◯ | ◯ | ◯ | ◯ | ◯ | ◯ | ◯ | X | X | X | X | X |

### INDUSTRIAL APPLICABILITY

The reinforced polypropylene resin composition of the present invention, reinforced with glass fibers, is excellent in the appearance of the molded body obtained therefrom, has high commercial value, and can be suitably used as a material for molded bodies that are excellent in mechanical characteristics in high temperature and high humidity environments in a variety of fields.

1. A reinforced polypropylene resin composition comprising:
10 to 70% by mass of a polypropylene resin (A);
15 to 40% by mass of a phosphorus-based flame retardant (B);
and
15 to 60% by mass of glass fibers (C),
with respect to 100% by mass of the total of the polypropylene resin (A), the phosphorus-based flame retardant (B), and the glass fibers (C), wherein the polypropylene resin (A) comprises
an unmodified polypropylene resin
(MFR (230° C., load of 2.16 kg) of 100 to 400 g/10 min) (A-1)
and
an acid modified polypropylene resin
(MFR (190° C., load of 2.16 kg) of 100 to 1000 g/10 min,
graft amount of acid modification monomers of 0.5 to 3.0% by mass, and
graft efficiency of acid modification monomers of more than 60%) (A-2).

2. The reinforced polypropylene resin composition according to claim 1, comprising:
20 to 60% by mass of the polypropylene resin (A);
20 to 35% by mass of the phosphorus-based flame retardant (B);
and
20 to 50% by mass of the glass fibers (C),
with respect to 100% by mass of the total of the polypropylene resin (A), the phosphorus-based flame retardant (B), and the glass fibers (C).

3. The reinforced polypropylene resin composition according to claim 1, wherein the acid modified polypropylene resin (A-2) has a melting point of 150 to 170° C.

4. The reinforced polypropylene resin composition according to claim 1, wherein the polypropylene resin (A) comprises the acid modified polypropylene resin (A-2) in a proportion of 0.1 to 3% by mass.

5. The reinforced polypropylene resin composition according to claim 1, wherein the phosphorus-based flame retardant (B) is a phosphate salt compound.

6. The reinforced polypropylene resin composition according to claim 1, further comprising carbon black in a proportion of 0.1 to 2 parts by mass with respect to 100 parts by mass of the total of the polypropylene resin (A), the phosphorus-based flame retardant (B), and the glass fibers (C).

7. A molded body formed from the reinforced polypropylene resin composition according to claim 1.
